(19) United States
(12) Patent Application Publication
(10) Pub. No.: US 2024/0405571 A1
(43) Pub. Date: Dec. 5, 2024

(54) Incomplete Dimensionality Augmentation-Based Optimization Method for Data-Driven Power System, and Application Thereof

(71) Applicant: Yunnan Power Grid Co., Ltd. Electric Power Research Institute, Kunming (CN)

(72) Inventors: Enbo LUO, Kunming (CN); Hai LU, Kunming (CN); Tianguo YANG, Kunming (CN); Hao ZHANG, Kunming (CN); Lijun TANG, Kunming (CN); Dada WANG, Kunming (CN); Yuxuan ZHANG, Kunming (CN)

(21) Appl. No.: 18/802,426

(22) Filed: Aug. 13, 2024

Related U.S. Application Data
(63) Continuation of application No. PCT/CN2022/099314, filed on Jun. 17, 2022.

(30) Foreign Application Priority Data
Feb. 24, 2022 (CN) 202210175951.7

(51) Int. Cl. H02J 3/46

(52) U.S. Cl. CPC H02J 3/46; H02J 2203/20; H02J 2300/24

(57) ABSTRACT

Disclosed is an incomplete dimensionality augmentation-based optimization method for a data-driven power system. By dividing a power flow independent variable into a control variable and a disturbance variable, such as power of a controllable power supply and an uncontrolled voltage amplitude, only the disturbance variable is subjected to dimensionality augmentation, to adapt to the nonlinear characteristic of the power flow; and the control variable keeps a power flow constraint as a linearized expression of the control variable, thereby simplifying a power flow constraint form and solution, and achieving a higher-accuracy of optimization. The power optimization scheduling of distributed photovoltaic can be implemented by the optimization method provided in the present invention.

### TECHNICAL FIELD

The present invention relates to a optimization method for a data-driven power system, and in particular, to an incomplete dimensionality augmentation linear regression-based optimization method for a data-driven power system.

### BACKGROUND

A power flow constraint, as a basic condition for system operation, is widely applied to the optimization of a power system. However, due to the non-convex nonlinear characteristic^{[1]} of a classical power flow equation, it is difficult to implement a rapid and global optimal solution when the power flow constraint directly serves as a constraint condition applied to optimization. In addition, many existing linearized and simplified power flow models depend on topological information and line parameters of a power grid, but it is difficult to obtain the above accurate parameters in the actual medium and low voltage distribution network, resulting in that the power flow constraint has low accuracy in the actual engineering and is difficult for actual application^{[2]}.

In view of the above problems, many different types of power flow equations have evolved in the existing research to meet the requirements of the optimization. At present power flow models can be divided into five types according to mathematical structures and parameter sources:
1) simplified power flow equation and equivalent approximation^{[3][4][5]}. According to this method, an original variable of a system is represented as a linearized form, but it is difficult to adapt to the nonlinear characteristic of the system under heavy load, large-scale distributed power supply access and other scenarios, so that the accuracy of the power flow is reduced, and the optimal operation control of the system cannot be met;
2) nonlinear power flow. A Distflow model widely applied to the optimization of a distribution network establishes a nonlinear relationship among the square of a voltage amplitude, the square of a branch current and a branch power, but still belongs to a non-convex nonlinear equation group. Convex relaxation is required for solution^{[6]}. However, convex relaxation optimization on an optimization target is required to be matched with a convex mode, so that the optimization result meets the power flow constraint, and the selection of the optimization target is limited;
3) power flow based on a new state space. According to a lot of research, many types of linearized power flow calculations^{[7][8]} have been established based on different state spaces and simplified models. By selecting the state spaces of different kernel functions, a linearized mathematic structure under the new state space can be obtained, and the accurate power flow computation result can be obtained to meet the nonlinear computation requirement of the distribution network under a large-range power fluctuation. However, the re-selected state space is limited by the kernel function, and threshold matching is requirement in the selection of a target function, thereby greatly limiting the application of the method in the optimization;
4) data-driven linearized power flow^{[2]}. Compared with a model-based linearized power flow, the data-driven linearized power flow has the advantage of not relying on grid topology and line parameter information, and has a higher engineering application value. However, the method is based on a linearized mathematic model, so the adaptability to the nonlinear characteristic of the system is also not achieved; and
5) dimensionality augmentation-based data-driven power flow^{[9]}. A nonlinear system in a low-dimensional space is described in a linearized model in a high-dimensional space through a dimensionality augmentation method, thereby achieving higher power flow computation accuracy for a system with strong nonlinearity. However, since that the dimensionality augmentation function has a complicated mathematic structure, the application in the optimal solution is limited.

In conclusion, the existing power flow constraint still has some defects and deficiencies:
(1) in the actual engineering, it is often difficult to obtain a timely network topology structure in a medium and low voltage distribution network, line parameters are not accurate, and a power flow model based on classical power flow equation derivation depends on accurate network parameters, resulting in a big error in the computation result and difficulty to meet the actual engineering requirement;
(2) in a power grid with heavy load and high distributed power supply penetration rate, the system will present higher nonlinear characteristic. A linearized power flow model is difficult to fit the nonlinear characteristic of the system, while a nonlinear power flow equation as a constraint has poor adaptability in solving the optimization problem, so the existing method is difficult to be compatible in easy solution and high accuracy; and
(3) in the linearized power flow model based on the re-selected state space, the high-accuracy state space has poor fit with the selection of the target function of the optimization model, and high-accuracy power flow constraints can be established on only few specific target functions, resulting in poor adaptability in the optimization of the power system

### REFERENCES

[1] Yang Z, Xie K, Yu J, et al. A General Formulation of Linear Power Flow Models: Basic Theory and Error Analysis[J]. IEEE Transactions on Power Systems, 2019, 34(2):1315 1324.
[2] [Liu Y, Zhang N, Wang Y, et al. Data-Driven Power Flow Linearization: A Regression Approach[J]. IEEE Transactions on Smart Grid, 2017, 10(3):2569-2580
[3] Sulc P, Backhaus S, Chertkov M. Optimal Distributed Control of Reactive Power Via the Alternating Direction Method of Multipliers[J]. IEEE Transactions on Energy Conversion, 2013, 29(4):968-977.
[4] Yang J, Zhang N, Kang C, et al. A State-Independent Linear Power Flow Model With Accurate Estimation of Voltage Magnitude[J]. IEEE Transactions on Power Systems, 2017, 32(5):3607-3617.
[5] T. Akbari and M. T. Bina, “Linear approximated formulation of ac optimal power flow using binary discretisation,” IET Gener. Transmiss. Distrib., vol. 10, no. 5, pp. 1117-1123, 2016.
[6] Baran, M, Wu, et al. Optimal sizing of capacitors placed on a radial distribution system[J]. Power Delivery IEEE Transactions on, 1989.
[7] Baran, M, Wu, et al. Optimal sizing of capacitors placed on a radial distribution system[J]. Power Delivery IEEE Transactions on, 1989.
[8] Yang Z, Zhong H, Xia Q, et al. A novel network model for optimal power flow with reactive power and network losses[J]. Electric Power Systems Research, 2017.
[9] Guo L, Zhang Y, Li X, et al. Data-driven Power Flow Calculation Method: A Lifting Dimension Linear Regression Approach[J]. IEEE Transactions on Power Systems. Early Access.

### SUMMARY

In view of the prior art, the present invention provides an incomplete dimensionality augmentation linear regression-based optimization method for a data-driven power system. Since the low-dimensional nonlinear system can be represented as a linearized system in a high-dimensional space, an appropriate kernel function can be selected, a power flow variable in a low-dimensional space is subjected to dimensionality augmentation, and a mapping relationship of the power flow computation is achieved in the high-dimensional space, thereby adapting to the nonlinear characteristic of a distributed power supply system with heavy load and high penetration rate. An independent variable of the system is divided into a control variable and a disturbance variable. In the method, only the disturbance variable is subjected to dimensionality augmentation, thereby fitting the nonlinearity of the system; and the control variable is not subjected to dimensionality augmentation to control the linear characteristic of the control variable in a power flow constraint, thereby optimizing the solution. The incomplete dimensionality augmentation-based data-driven power flow constraint optimization can achieve the optimization effect with higher accuracy while meeting the characteristic of easy solution.

To solve the above technical problem, the present invention provides an incomplete dimensionality augmentation-based optimization method for a data-driven power system. In the optimization method, a power flow independent variable is divided into a control variable u and a disturbance variable x; the control variable u serves as an optimization variable in an optimization problem; the disturbance variable is an uncontrolled independent variable; the control variable u is not subjected to dimensionality augmentation to keep a power flow constraint as a linearized expression of the control variable u; and the disturbance variable x is subjected to dimensionality augmentation to adapt to the nonlinear characteristic of the power flow through a nonlinear function in a dimensionality augmentation function. The optimization method includes the following steps:
step 1) performing classified correspondence on historical operation data of a power grid analysis object, including a control variable u, a disturbance variable x and a state variable y in an independent variable of a power flow variable, where the control variable u selects an output active power P_{DG} and a reactive power Q_{DG} of a controllable power supply in the power grid, u=[P_{DG} Q_{DG}]^{T}; the disturbance variable x includes a voltage amplitude V_{ref} of a balance node, a node injection active power P_{PQ} and a node injection reactive power Q_{PQ} of a PQ node, and a node injection active power P_{PV} and a voltage amplitude V_{PV} of a PV node, x=[V_{ref}, P_{PQ}, Q_{PQ}, P_{PY}, V_{PV}]^{T}; and the state variable y is selected according to the computation requirement;
step 2) performing dimensionality augmentation computation on the disturbance variable x by the following formula to obtain a disturbance variable x_{lift} after dimensionality augmentation,

$${x}_{lift} = [ \begin{matrix}x \\ ψ ( x )\end{matrix} ]$$

where ψ(x) is a dimensionality augmentation operation function of an input vector x;
step 3) establishing an incomplete dimensionality augmentation-based power system data-driven power flow algorithm by the following formula, performing parametric regression by a least square method, and determining a power flow mapping matrix M to implement high-accuracy power flow mapping on a state variable y by the control variable u and the disturbance variable x,

$$y = [ M ] [ \begin{matrix}u \\ x \\ ψ ( x )\end{matrix} ] = {M}_{0} u + {M}_{1} [ \begin{matrix}x \\ ψ ( x )\end{matrix} ] = {M}_{0} u + {M}_{1} {x}_{lift}$$

where in the formula, M₀ and M₁ are partitioned matrices of a matrix M, and the disturbance variable x and the state variable y specifically include:

$$x = {[ {V}_{ref} , {P}_{P Q} , {Q}_{P Q} , {P}_{P V} , {V}_{P V} ]}^{T} \\ y = {[ {V}_{P Q} , {P}_{L} , {Q}_{L} , … ]}^{T}$$

performing least square estimation based on the linear structure of the following formula to determine a mapping relationship matrix M of the power flow; and

y=Mx_{lift}
step 4) establishing an incomplete dimensionality augmentation power flow constraint on the control variable u, the disturbance variable x and the state variable y through the matrix M obtained in the step 3), performing integration in a traditional optimization framework, and establishing an optimization target function so as to obtain an incomplete dimensionality augmentation-based optimization model for the data-driven power system, and performing operation optimization on the data-driven power system based on the optimization model.

Further, in the step 2) of the optimization method,
when the dimensionality augmentation function is used to augment N dimensions, the basic structure of a dimensionality augmentation operation function is shown as follows:

$$ψ ( x ) = [ \begin{matrix}{ψ}_{1} ( x ) \\ ⋮ \\ {ψ}_{N} ( x )\end{matrix} ]$$

In a dimensionality augmentation element based on a nonlinear function, it is necessary to select different base vectors c to augment different dimensions:

$${ψ}_{i} ( x ) = {f}_{lift} ( x - {c}_{i} )$$

In the formula, cᵢ is an augmented i^{th}-dimension base vector, cᵢ∈R^{1×k}; a base may select any random number within a variable value; and a dimensionality augmentation function based on a logarithmic function is given as follows:

$${f}_{lift} ( x - {c}_{i} ) = \sqrt{{\sum }_{j = 1}^{k} {( {x}_{i} - {c}_{ij} )}^{2}} log \sqrt{{\sum }_{j = 1}^{k} {( {x}_{i} - {c}_{ij} )}^{2}} .$$

The power optimization scheduling of distributed photovoltaic can be implemented by the optimization method provided in the present invention, including:
the established incomplete dimensionality augmentation power flow mapping relationship of the distributed photovoltaic is as follows:

$${V}_{P Q} = M [ \begin{matrix}{P}_{D G} \\ {Q}_{D G} \\ x \\ ψ ( x )\end{matrix} ] = {M}_{0} [ \begin{matrix}{P}_{D G} \\ {Q}_{D G}\end{matrix} ] + {M}_{1} [ \begin{matrix}x \\ ψ ( x )\end{matrix} ]$$

In the formula, V_{PQ} represents a voltage amplitude of a PQ node.

A distributed power supply power optimization scheduling model of a power flow constraint constructed based on the incomplete dimensionality augmentation power flow mapping relationship expression of the distributed photovoltaic is:

$$\begin{matrix}Min & \sum \vert {Q}_{D G} - {Q}_{D G}^{′} \vert \\ s . t . & \{ \begin{matrix}{V}_{min} \leq {M}_{0} [ \begin{matrix}{P}_{D G} \\ {Q}_{D G}\end{matrix} ] {P}_{D G} + {M}_{1} [ \begin{matrix}x \\ ψ ( x )\end{matrix} ] \leq {V}_{max} \\ {P}_{D G}^{2} + {Q}_{D G}^{2} \leq {S}_{D G}^{2}\end{matrix}\end{matrix}$$

In the formula, Q_{DG}′ is a reactive power output vector before regulation of the distributed photovoltaic; Vₘᵢₙ and Vₘₐₓ respectively represent an upper limit and a lower limit of a voltage amplitude of an analysis distribution network; S_{DG} represents a vector of a photovoltaic installed capacity; and P_{DG}², Q_{DG}² and S_{DG}² respectively represent the square of each of P_{DG}, Q_{DG} and S_{DG}.

Compared with the prior art, the present invention has the following beneficial effects:
1) compared with a physical model-based power flow constraint, the method does not depend on the actual grid topology and line parameters, avoids a power flow constraint error caused by a parameter error, and has a higher application value in the actual engineering;
2) the disturbance variable is subjected to dimensionality augmentation to fit the nonlinear characteristic of the system in the high-dimensional space, thereby achieving higher constraint accuracy compared with the linearized power flow constraint; and
3) compared with an existing nonlinear power flow constraint equation, since the state space of a new control variable is not defined, the method has higher target function adaptability, while the power flow constraint is represented as a linear equation of the control variable, thereby remaining the easy solution characteristic of the constraint.

### BRIEF DESCRIPTION OF DRAWINGS

To describe the technical solutions in the embodiments of the present application or in the prior art more clearly, the drawings that are required to be used in the description of the embodiments or the prior art are briefly introduced below. Apparently, the drawings in the description below show merely some embodiments of the present application, and those of ordinary skill in the art may also acquire other drawings based on these drawings without any creative efforts.

In the drawings:

FIG. 1 is a basic topological diagram according to an embodiment of the present invention;

FIG. 2 is a comparison diagram of node voltage distribution between a method according to the present invention and a control method when an optimization objective is to minimize an average voltage deviation rate;

FIG. 3 is a comparison diagram of a reactive power regulation quantity between a method according to the present invention and a control method when an optimization objective is to minimize an average voltage deviation rate;

FIG. 4 is a comparison diagram of an optimization result of an average voltage deviation rate between a method according to the present invention and a control method when an optimization objective is to minimize the average voltage deviation rate;

FIG. 5 is a comparison diagram of node voltage distribution between a method according to the present invention and a control method when an optimization objective is to minimize a distributed power supply reactive power regulation quantity; and

FIG. 6 is a comparison diagram of a reactive power regulation quantity between a method according to the present invention and a control method when an optimization objective is to minimize a distributed power supply reactive power regulation quantity.

### DETAILED DESCRIPTION OF THE EMBODIMENTS

The present invention will be further described with reference to the accompanying drawings and specific embodiments, but the following embodiments do not limit the present invention.

A design idea of an incomplete dimensionality augmentation-based optimization method for a data-driven power system provided in the present invention is to further divide a power flow independent variable into a control variable u and a disturbance variable x. The control variable u, as an optimal variable in an optimization problem, can select output active and reactive powers P_{DG} and Q_{DG} of a controllable device in a power grid, such as a controllable power supply, and operation states of other controlled devices, u=[P_{DG} Q_{DG}]^{T}. The disturbance variable is an uncontrolled independent variable, for example, a voltage amplitude V_{ref} of a balance node, a node injection active P_{PQ} and a node injection reactive power Q_{PQ} of a PQ node, and a node injection active power P_{PV} and a voltage amplitude V_{PV} of a PV node, x=[V_{ref}, P_{PQ}, Q_{PQ}, P_{PV}, V_{PV}]^{T}. In the present invention, only the disturbance variable x is subjected to dimensionality augmentation, to adapt to the nonlinear characteristic of the power flow through a nonlinear function in a dimensionality augmentation function; and the control variable u is not subjected to dimensionality augmentation to keep a power flow constraint as a linearized expression of u, thereby simplifying a power flow constraint form and solution.

I. The main contents of the optimization method provided in the present invention are as follows:

### 1-1. Dimensionality Augmentation-Based Data-Driven Power Flow Computation

A power flow equation in a power system in a low-dimensional space is a nonlinear equation group, and a linear relationship^{[10]} between input and output variables can be obtained after dimensionality augmentation of the input and output variables in the power flow computation.
1) High-dimensional linear relationship. If a nonlinear equation group y=f(x) is present, where x and y are column vectors, x∈R^{1×k} and y∈R^{1×I}; and x is subjected to dimensionality augmentation transformation shown in formula (1), where ψ(x) is a dimensionality augmentation computation function of an input vector x.

$${x}_{lift} = [ \begin{matrix}x \\ ψ ( x )\end{matrix} ] \qquad ( 1 )$$

Then an operator M meets a linear mapping relationship shown in formula (2):

$$y = M {x}_{lift} \qquad ( 2 )$$

2) Dimensionality augmentation function. When the dimensionality augmentation function is used to augment N dimensions, the basic structure of a dimensionality augmentation operation function is shown in the following formula (3).

$$ψ ( x ) = [ \begin{matrix}{ψ}_{1} ( x ) \\ ⋮ \\ {ψ}_{N} ( x )\end{matrix} ] \qquad ( 3 )$$

In a dimensionality augmentation element based on a nonlinear function, it is necessary to select different base vectors c to augment different dimensions:

$${ψ}_{i} ( x ) = {f}_{lift} ( x - {c}_{i} ) \qquad ( 4 )$$

In the formula, cᵢ is an augmented i^{th}-dimension base vector, cᵢ∈R^{1×k}; a base may select any random number within a variable value. A dimensionality augmentation function based on a logarithmic function is given as shown in formula (5):

$${f}_{lift} ( x - {c}_{i} ) = \sqrt{{\sum }_{j = 1}^{k} {( {x}_{i} - {c}_{ij} )}^{2}} log \sqrt{{\sum }_{j = 1}^{k} {( {x}_{i} - {c}_{ij} )}^{2}} \qquad ( 5 )$$

### 1-2. Dimensionality Augmentation-Based Data-Driven Power Flow Computation

### 1) Basic Form of Power Flow Computation

$$x = {[ {V}_{r e f} , {P}_{P Q} , {Q}_{P Q} , {P}_{PV} , {V}_{P V} ]}^{T} y = {[ {V}_{P Q} , {P}_{L} , {Q}_{L} , … ]}^{T} \qquad ( 6 )$$

In power flow computation, the selection of the independent variable includes: a voltage amplitude of a balance node, a node injection active power and a node injection reactive power of a PQ node, and a node injection active power and a voltage amplitude of a PV node, sequentially and correspondingly as follows: V_{ref}, P_{PQ}, Q_{PQ}, P_{PV} and V_{PV}; however, dependent variables are only to describe the specific state of the system under the dependent variables, each dependent variable is independent in computation, so selection can be performed according to the computation requirements, such as a voltage amplitude V_{PQ} of the PQ node, and branch active and reactive powers P_{L} and Q_{L}.

### 2) Least Square Estimation

According to the power flow computation requirement, historical operation data of a power grid analysis object correspond to an independent variable X and a dependent variable Y, and least square estimation is performed based on a linear structure of formula (2) so as to determine a mapping relationship matrix M of the power flow.

### 1-3 Incomplete Dimensionality Augmentation-Based Data-Driven Power Flow Optimization Method

Since complete dimensionality augmentation introduce all power flow independent variables into the computation of a dimensionality augmentation function, the power flow equation is represented as nonlinear equations of all the independent variables, and the complicated dimensionality augmentation function leads that the difficult solution of the power flow as a constraint condition. The application of a dimensionality augmentation-based data-driven power flow model in the optimization problem is limited.

Therefore, according to the present invention, the power flow independent variable is further divided into a control variable u and a disturbance variable x. The control variable u, as an optimal variable in an optimization problem, can select output active and reactive powers P_{DG} and Q_{DG} of a controllable device in a power grid, such as a controllable power supply, and operation states of other controlled devices, u=[P_{DG} Q_{DG}]^{T}. The disturbance variable is an uncontrolled independent variable, for example, a voltage amplitude V_{ref} of a balance node, a node injection active power P_{PQ} and a node injection reactive power Q_{PQ} of a PQ node, and a node injection active power P_{PV} and a voltage amplitude V_{PV} of a PV node, x=[V_{ref}, P_{PQ}, Q_{PQ}, P_{PV}, V_{PV}]^{T}.

In the present invention, only the disturbance variable xis subjected to dimensionality augmentation, to adapt to the nonlinear characteristic of the power flow through a nonlinear function in a dimensionality augmentation function; and the control variable u is not subjected to dimensionality augmentation to keep a power flow constraint as a linearized expression of u, thereby simplifying a power flow constraint form and solution. Based on the above idea, an incomplete dimensionality augmentation expression is shown in formula (7).

$$y = [ M ] [ \begin{matrix}u \\ x \\ ψ ( x )\end{matrix} ] = {M}_{0} u + {M}_{1} [ \begin{matrix}x \\ ψ ( x )\end{matrix} ] = {M}_{0} u + {M}_{1} {x}_{lift} \qquad ( 7 )$$

In the formula, M₀ and M₁ are partitioned matrices of a matrix M.

1-4. The incomplete dimensionality augmentation-based optimization for the data-driven power system provided in the present invention includes the following steps:
step 1) classified correspondence is performed on historical operation data of a power grid analysis object, including a control variable u, a disturbance variable x and a state variable y in independent variables of the power flow variables. The control variable u, as an optimal variable in an optimization problem, can select an output power of a controllable device in a power grid, such as a controllable power supply, operation states of other controlled devices, and output active power P_{DG} and reactive power Q_{DG} of the controllable power supply, u=[P_{DG} Q_{DG}]^{T}; the disturbance variable x is an uncontrolled independent variable, such as uncontrolled load and power supply power variable, and may include a voltage amplitude V_{ref} of a balance node, a node injection active power P_{PQ} and a node injection reactive power Q_{PQ} of a PQ node, and a node injection active power P_{PV} and a voltage amplitude V_{PV} of a PV node, x=[V_{ref}, P_{PQ}, Q_{PQ}, P_{PV}, V_{PV}]^{T}; and a dependent variable y can be selected according to the computation requirement, such as a voltage amplitude of a node;
step 2) dimensionality augmentation computation is performed on the disturbance variable x by formula (1) to obtain a disturbance variable x_{lift} after dimensionality augmentation;
step 3) an incomplete dimensionality augmentation-based power system data-driven power flow algorithm is established by formula (7), parametric regression is performed by a least square method, and a power flow mapping matrix M is determined to implement high-accuracy power flow mapping on y by the control variable u and the disturbance variable x; and
step 4) an incomplete dimensionality augmentation power flow constraint on the control variable u, the disturbance variable x and the state variable y is established through the matrix M obtained in the step 3), integration is performed in a traditional optimization framework, and an optimization target function is established so as to obtain an incomplete dimensionality augmentation-based optimization model for the data-driven power system, and operation optimization is performed on the data-driven power system based on the optimization model.

Taking the power optimization scheduling of the distributed photovoltaic as an example, the incomplete dimensionality augmentation power flow mapping relationship established by the distributed photovoltaic is shown in formula (8).

$${V}_{P Q} = M [ \begin{matrix}{P}_{DG} \\ {Q}_{D G} \\ x \\ ψ ( x )\end{matrix} ] = {M}_{0} [ \begin{matrix}{P}_{D G} \\ {Q}_{D G}\end{matrix} ] + {M}_{1} [ \begin{matrix}x \\ ψ ( x )\end{matrix} ] \qquad ( 8 )$$

In the formula, V_{PQ} represents a voltage amplitude of a PQ node; and x is a disturbance variable (all other independent variables except the control variable, such as active and reactive powers of a load node, and a voltage amplitude of a balance node).

A distributed power supply power optimization scheduling model of a power flow constraint is constructed based on formula (8). Under an overvoltage scenario, taking a target function of a minimum reactive regulation quantity of the distributed power supply as an example, the optimization model is as follows:

$$\begin{matrix}Min & \sum \vert {Q}_{D G} - {Q}_{DG}^{′} \vert \\ s . t . & \{ \begin{matrix}{V}_{min} \leq {M}_{0} [ \begin{matrix}{P}_{D G} \\ {Q}_{D G}\end{matrix} ] {P}_{D G} + {M}_{1} [ \begin{matrix}x \\ ψ ( x )\end{matrix} ] \leq {V}_{max} \\ {P}_{D G}^{2} + {Q}_{DG}^{2} \leq {S}_{D G}^{2}\end{matrix}\end{matrix} \qquad ( 9 )$$

$$\begin{matrix}Min & \sum \vert {Q}_{D G} - {Q}_{DG}^{′} \vert \\ s . t . & \{ \begin{matrix}{V}_{min} \leq {M}_{0} [ \begin{matrix}{P}_{D G} \\ {Q}_{D G}\end{matrix} ] {P}_{D G} + {M}_{1} [ \begin{matrix}x \\ ψ ( x )\end{matrix} ] \leq {V}_{max} \\ {P}_{D G}^{2} + {Q}_{DG}^{2} \leq {S}_{D G}^{2}\end{matrix}\end{matrix} \qquad ( 9 )$$

In the formula, Q_{DG}′ is a reactive power output vector before regulation of the distributed photovoltaic; Vₘᵢₙ and Vₘₐₓ respectively represent an upper limit and a lower limit of a voltage amplitude of an analysis distribution network; S_{DG} represents a vector of a photovoltaic installed capacity; and P_{DG}², Q_{DG}² and S_{DG}² respectively represent the square of each of P_{DG}, Q_{DG} and S_{DG}.

### II. Research Material

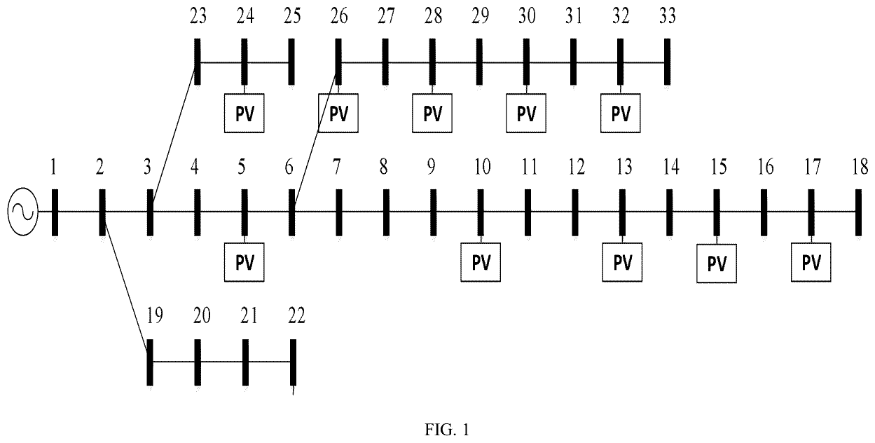

An IEEE33 node system is used for verification, including 11 distributed power supply access points, and the specific topology is shown in FIG. 1.

The overvoltage scenario is selected to verify the effectiveness of the present invention, the maximum voltage is 1.077 (p.u.), the line always has a reversely delivered active power of 3.34 MW, and the reactive power is not reversely delivered and is 1.36 MVar. The scenario has the nonlinear characteristic due to high reversely delivered power and non-reversely delivered reactive power.

A certain overvoltage problem occurs in the distribution network when the output power of the distributed power supply is high, and the reactive power of the distributed power supply can be regulated, so that the operation of the power grid meets the voltage constraint.

Two embodiments are established to describe the incomplete dimensionality augmentation power flow constraint of the present invention has higher computation accuracy compared with the linear power flow model without depending on the accurate topological information and line parameters of the power grid. Embodiment 1 and Embodiment 2 respectively take the minimum voltage deviation rate and the minimum distributed power supply reactive power regulation quantity as optimization objectives so as to establish an optimization model based on a voltage constraint of the distribution network and an operation constraint of the distributed power supply. Embodiments adopt a decoupled linearized power flow (DLPF)-based optimization model in reference [4] as a control method for comparison.

### Embodiment 1

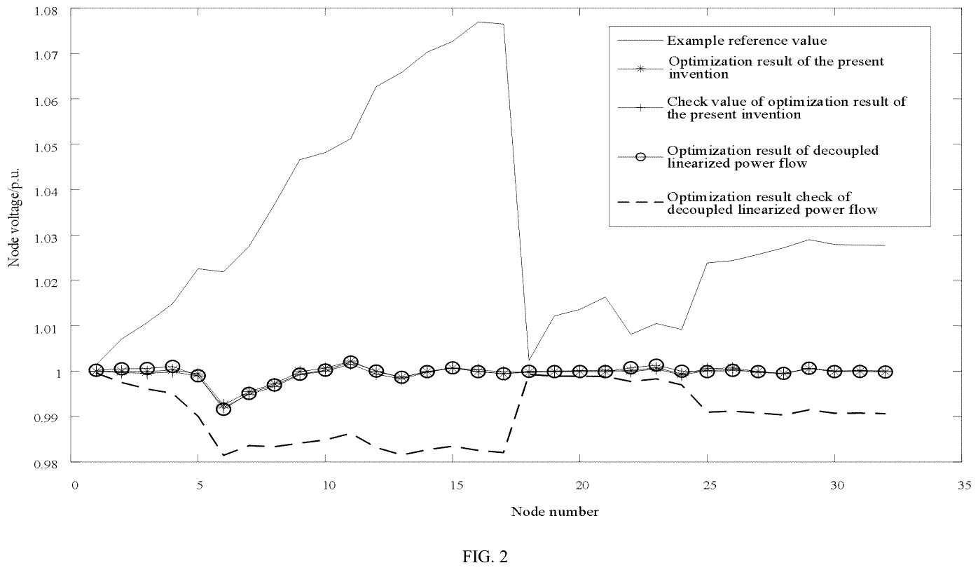

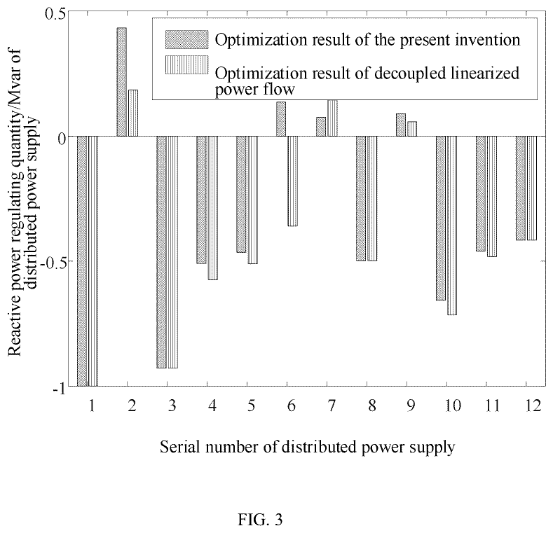

FIG. 2 is a comparison diagram of a node voltage distribution between a method provided in the present invention and the DLPF-based power flow optimization model [4]. After regulation, the theoretical regulation results of the two methods are very close, and the voltages are kept at around 1. Taking a Newton-Raphson accurate power flow computation result as a benchmark, the regulation power results of the two optimization methods are verified to evaluate the regulation accuracy. Due to the adoption of a simple linear model, the control method cannot adapt to the strong nonlinear characteristic after the distributed power supply with high penetration rate is accessed to the distribution network, with a large error level. In the control method, the average voltage error is 0.009173 and the maximum voltage error is 0.017370; and in the method provided in the present invention, the average voltage error and the maximum voltage error are respectively 0.000612 and 0.002434, and are respectively 25.14% and 14.01% of the control method, with higher regulation accuracy. FIG. 3 is a comparison diagram of a distributed power supply reactive power regulation quantity between a method according to the present invention and a control method.

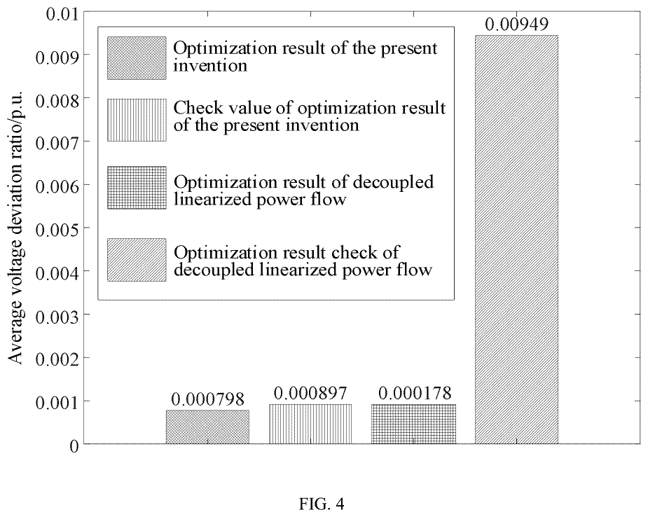

FIG. 4 is an optimization objective of the method according to the present invention and a control method, that is, an average voltage deviation rate of the power grid, and the theoretical regulation result of the control method is 0.000878. The linear model cannot match the nonlinear characteristic of the system during high-power reverse delivery of the system, so the actual regulation result is 0.00949, and the relative error reaches 90.75%. In the method provided in the present invention, the optimization result is 0.000798, the actual regulation result is 0.000897, and the relative error is 11.04%. Compared with the control method, the method provided in the present invention can achieve higher regulation and control precision without depending on any network topological information and line parameters.

### Embodiment 2

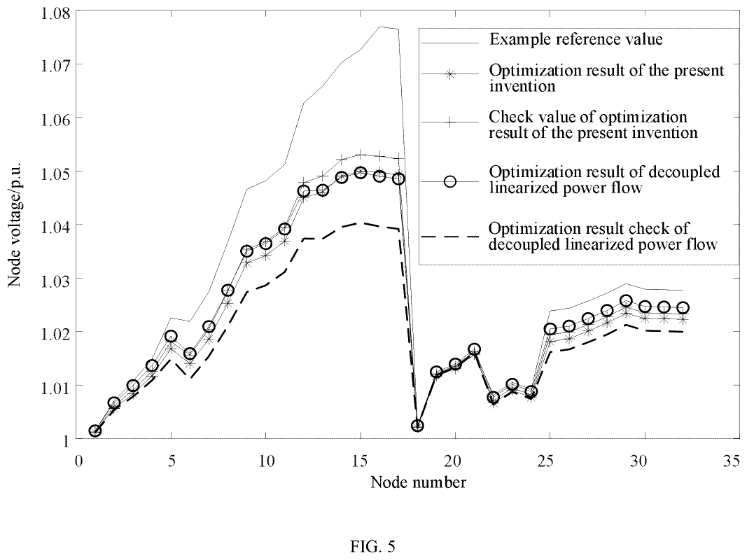

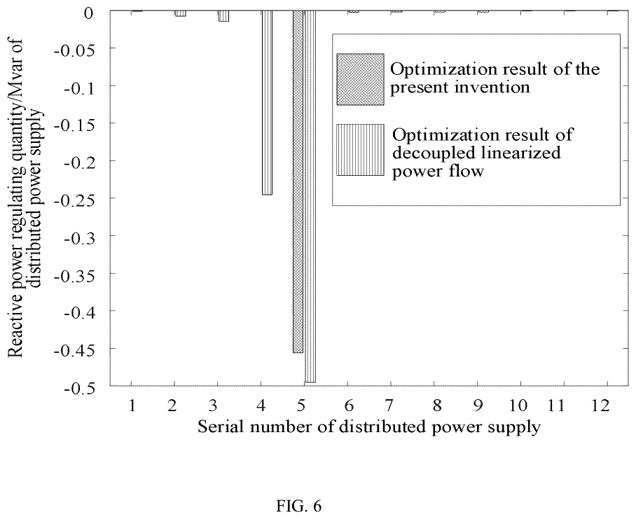

FIG. 5 is a comparison diagram of a node voltage distribution between the method provided in the present invention and the control method. Before regulation, the maximum overvoltage exceeds 1.07 (per-unit value), and an upper limit of a normal operation voltage is set to 1.05 (per-unit value); after optimization, it can be seen that the voltage can be effectively controlled by the method provided in the present invention and the control method, and the voltage constraint is met after regulation; and due to the power flow error between the method and the control method, the actual regulation value is different from the theoretical optimization value, where the voltage in the method provided in the present invention after regulation is higher, and the voltage in the control method is lower. By comparing the regulation results of the two methods, the average voltage error and the maximum voltage error in the control method are respectively 0.004643 and 0.009381, the average voltage error and the maximum voltage error of the regulation result of the method provided in the present invention are respectively 0.002273 and 0.003944, and are respectively 48.96% and 42.04% of the control method, with a lower voltage regulation error. FIG. 6 is a distributed power supply reactive power regulation quantity corresponding to FIG. 5. The method has lower regulation voltage error and lower distributed power supply reactive power regulation quantity.

The present invention is described above in conjunction with the accompanying drawings. However, the present invention is not limited to the above specific embodiments; and the above specific embodiments are merely illustrative and not limiting. Those of ordinary skill in the art may, under the inspiration of the present invention, further make various forms, which all fall within the protection of the present invention, without departing from the spirit of the present invention.

1. An incomplete dimensionality augmentation-based optimization method for a data-driven power system, wherein in the optimization method, a power flow independent variable is divided into a control variable u and a disturbance variable x; the control variable u serves as an optimization variable in an optimization problem; the disturbance variable is an uncontrolled independent variable; the control variable u is not subjected to dimensionality augmentation to keep a power flow constraint as a linearized expression of the control variable u; and the disturbance variable x is subjected to dimensionality augmentation to adapt to the nonlinear characteristic of the power flow through a nonlinear function in a dimensionality augmentation function.

2. The optimization method according to claim 1, comprising the following steps:
step 1) performing classified correspondence on historical operation data of a power grid analysis object, including a control variable u, a disturbance variable x and a state variable y in an independent variable of a power flow variable, where the control variable u selects an output active power P_{DG} and a reactive power Q_{DG} of a controllable power supply in the power grid, u=[P_{DG} Q_{DG}]^{T}; the disturbance variable x includes a voltage amplitude V_{ref} of a balance node, a node injection active power P_{PQ} and a node injection reactive power Q_{PQ} of a PQ node, and a node injection active power P_{PV} and a voltage amplitude V_{PV} of a PV node, x=[V_{ref}, P_{PQ}, Q_{PQ}, P_{PV}, V_{PV}]^{T}; and the state variable y is selected according to the computation requirement;
step 2) performing dimensionality augmentation computation on the disturbance variable x by the following formula to obtain a disturbance variable x_{lift} after dimensionality augmentation,
$${x}_{lift} = [ \begin{matrix}x \\ ψ ( x )\end{matrix} ]$$
where ψ(x) is a dimensionality augmentation operation function of an input vector x;
step 3) establishing an incomplete dimensionality augmentation-based power system data-driven power flow algorithm by the following formula, performing parametric regression by a least square method, and determining a power flow mapping matrix M to implement high-accuracy power flow mapping on a state variable y by the control variable u and the disturbance variable x;
$$y = [ M ] [ \begin{matrix}u \\ x \\ ψ ( x )\end{matrix} ] = {M}_{0} u + {M}_{1} [ \begin{matrix}x \\ ψ ( x )\end{matrix} ] = {M}_{0} u + {M}_{1} {x}_{lift}$$
where in the formula, M₀ and M₁ are partitioned matrices of a matrix M, and the disturbance variable x and the state variable y specifically include:
$$x = {[ {V}_{r e f} , {P}_{P Q} , {Q}_{P Q} , {P}_{P V} , {V}_{P V} ]}^{T} \\ y = {[ {V}_{P Q} , {P}_{L} , {Q}_{L} , … ]}^{T}$$
performing least square estimation based on the linear structure of the following formula to determine a mapping relationship matrix M of the power flow; and
y=Mx_{lift}
step 4) establishing an incomplete dimensionality augmentation power flow constraint on the control variable u, the disturbance variable x and the state variable y through the matrix M obtained in the step 3), performing integration in a traditional optimization framework, and establishing an optimization target function so as to obtain an incomplete dimensionality augmentation-based optimization model for the data-driven power system, and performing operation optimization on the data-driven power system based on the optimization model.

3. The optimization method according to claim 2, wherein in the step 2),
when the dimensionality augmentation function is used to augment N dimensions, the basic structure of a dimensionality augmentation operation function is shown as follows:
$$ψ ( x ) = [ \begin{matrix}{ψ}_{1} ( x ) \\ ⋮ \\ {ψ}_{N} ( x )\end{matrix} ]$$
in a dimensionality augmentation element based on a nonlinear function, it is necessary to select different base vectors c to augment different dimensions:
$${ψ}_{i} ( x ) = {f}_{lift} ( x - {c}_{i} )$$
in the formula, cᵢ is an augmented i^{th}-dimension base vector, cᵢ∈R^{1×k}; a base may select any random number within a variable value; and a dimensionality augmentation function based on a logarithmic function is given as follows:
$${f}_{lift} ( x - {c}_{i} ) = \sqrt{{\sum }_{j = 1}^{k} {( {x}_{i} - {c}_{ij} )}^{2}} log \sqrt{{\sum }_{j = 1}^{k} {( {x}_{i} - {c}_{ij} )}^{2}}$$

4. Application of the optimization method according to claim 3, wherein power optimization scheduling of distributed photovoltaic is implemented;
the established incomplete dimensionality augmentation power flow mapping relationship of the distributed photovoltaic is as follows:
$${V}_{P Q} = M [ \begin{matrix}{P}_{D G} \\ {Q}_{D G} \\ x \\ ψ ( x )\end{matrix} ] = {M}_{0} [ \begin{matrix}{P}_{D G} \\ {Q}_{D G}\end{matrix} ] + {M}_{1} [ \begin{matrix}x \\ ψ ( x )\end{matrix} ]$$
in the formula, V_{PQ} represents a voltage amplitude of a PQ node;
a distributed power supply power optimization scheduling model of a power flow constraint constructed based on the incomplete dimensionality augmentation power flow mapping relationship expression of the distributed photovoltaic is:
$$\begin{matrix}Min & \sum \vert {Q}_{D G} - {Q}_{DG}^{′} \vert \\ s . t . & \{ \begin{matrix}{V}_{min} \leq {M}_{0} [ \begin{matrix}{P}_{D G} \\ {Q}_{D G}\end{matrix} ] {P}_{D G} + {M}_{1} [ \begin{matrix}x \\ ψ ( x )\end{matrix} ] \leq {V}_{max} \\ {P}_{D G}^{2} + {Q}_{DG}^{2} \leq {S}_{D G}^{2}\end{matrix}\end{matrix}$$
in the formula, Q_{DG}′ is a reactive power output vector before regulation of the distributed photovoltaic; Vₘᵢₙ and Vₘₐₓ respectively represent an upper limit and a lower limit of a voltage amplitude of an analysis distribution network; S_{DG} represents a vector of a photovoltaic installed capacity; and P_{DG}², Q_{DG}² and S_{DG}² respectively represent the square of each of P_{DG}, Q_{DG} and S_{DG}.
